(19) United States
(12) Patent Application Publication
(10) Pub. No.: US 2002/0099457 A1
(43) Pub. Date: Jul. 25, 2002

(54) System and method for representing an activity involving a route along a plurality of locations

(76) Inventors: John R. Fredlund, Rochester, NY (US); John R. Squilla, Rochester, NY (US); Richard G. Mackson, Pittsford, NY (US); David A. Podsedly, Fairport, NY (US); Joseph A. Manico, Rochester, NY (US)

Correspondence Address: Thomas H. Close, Patent Legal Staff, Eastman Kodak Company, 343 State Street, Rochester, NY, 14650-2201, US

(21) Appl. No.: 09/769,986

(22) Filed: Jan. 25, 2001

(51) Int. Cl. G06F 155/00

(52) U.S. Cl. 700/91

(57) ABSTRACT

A system that creates a record of an activity that involves a route including visits to a plurality of locations. The record is of an aesthetic appeal and useful for recording the specifics of the activity. The participant of the activity carries a recording device that records the coordinates of locations visited. This information is downloaded to a processing computer, and a keepsake is created.

### FIELD OF THE INVENTION

The present invention relates to a system and method of capturing and displaying data representing an activity along a plurality of locations, such as golf or hiking.

### BACKGROUND OF THE INVENTION

Golf courses provide score cards to allow the golfers to record their scores. These score cards are useful in many ways. For example, generally a course name and logo are displayed on the card. Course information is displayed on the card so that the golfer will know approximate distances to the hole. Par information is displayed for each hole. The golfer can record the number of strokes taken to complete each hole, and upon completion of the course, can tally up all strokes for the final score.

Golfers often retain score cards as a keepsake of the course, the particular round, or the score on a particular hole. The score card is useful to trigger the memory of the golfer, but it is a very limited keepsake. For example, the score card is particularly limited in its visual aspects in that the recorded numbers are a poor representation of success on the course, and of the physical beauty of the course. Additionally, the score card provides limited information on how the course was played by the golfer. The number of strokes is recorded, but not the position or difficulty of the shots. Further, the score card does not lend itself well to improving the golfer's game.

Similarly, hikers treasure the maps of routes they have taken, and often retain the maps as a keepsake. The hikers sometimes even manually record their routes on the maps. These maps are often large and unwieldy and often display areas well beyond the area of travel. In most cases the map is an impersonal remembrance of the trip.

In U.S. Pat. No. 5,810,580, Lobb discloses a computer-aided game apparatus for providing information and for assisting a golfer during the progress of the game. The apparatus includes a printer to allow the golfer to download the golfer's game statistics. Fraker, in U.S. Pat. No. 5,434,789, shows a golf diagnostic system that records ball positions on the basis of global positioning system (GPS) readings, and may be used for keeping track of scores obtained. In U.S. Pat. No. 5,507,485, Fisher shows a portable golf computer that is programmed to record a golfers score, determine the location of the cart and/or golfer, and display the layout of each hole on the golf computer. None of the aforementioned systems provide a keepsake of more value than a traditional score card.

### SUMMARY OF THE INVENTION

It is an object of the present invention to provide a system that automatically creates a record of an activity that is of superior aesthetic appeal and of more use for recording the specifics of the locations visited.

This object is achieved by creating an image representing an activity involving a route including visits to a plurality of locations, comprising the steps of:

a) providing a participant in the activity with a recording device for recording the coordinates of his location;

b) participating in the activity accompanied by the recording device; and

c) employing the coordinates recorded by the recording device to produce an image showing the route taken by the participant during the activity.

### BRIEF DESCRIPTION OF THE DRAWINGS

FIG. 1 depicts a device used for recording ball placement and recording strokes;

FIG. 2 is a block diagram of the device shown in FIG. 1;

FIG. 3 is a diagram of a system for creating a record of an activity according to the present invention;

FIG. 4 is a diagram showing a golf course and a route taken by a particular golfer produced according to one embodiment of the present invention;

FIG. 5 depicts a golfing keepsake produced according to an alternative embodiment of the present invention;

FIG. 6 depicts a golfing keepsake in accordance with the present invention;

FIG. 7 is a flowchart of a method that implements the present invention; and

FIG. 8 depicts a keepsake provided to a hiker in accordance with the present invention.

### DETAILED DESCRIPTION OF THE INVENTION

In general, the present invention can be used to record a particular route taken during an activity and produce a keepsake, such as a map, showing the route taken. The keepsake may be a print of an image, or other object bearing an image, such as a map, postcard, tee-shirt, mug, or album. The activity may be discrete or be comprised of a round of activity. Examples of such activities include golfing, hiking, long distance running, mountain climbing, fishing, bicycling, skiing, boating, road rallys, and vacation travel. For ease of explanation, the present invention will be described using the activity of golfing.

FIG. 1 shows a recording device used in accordance with the present invention to record the stroke locations in a round of golf. The recording device 10 includes a ball placement button 12 that is pressed whenever the golfer is about to strike the ball. Alternatively, the ball placement button 12 may be actuated just after the ball is stuck. The golfer stands at the stroke location and presses the placement button 12 whenever a stroke is taken. Alternatively, a remote triggering device 14 may be provided to remotely trigger recording device 10. That is, the golfer wears the recording device 10 and a caddy or playing partner, triggers a ball placement button 12 disposed on the remote triggering device 14 to record the position of the ball for each stroke. The recording device 10 records that a stroke has been taken, and the location on the course where the ball placement button 12 was pressed. In this manner, the number of strokes and the location from which each stroke was taken is recorded.

The recording device 10 may also include a hole button 16 that is pressed when the golfer has sunk a putt in the hole. When the hole button 16 is pressed, the recording device 10 will record that the golfer has finished the hole and record the score for that hole. Alternative means may be used to record the finish of a hole such as a double actuation, or a long duration actuation of the ball placement button 12. Another alternative is a sensor disposed in the bottom of the cup on the green, indicating that the golfer has sunk a putt in the hole, thereby recording that the golfer has finished the hole. A bar code on the golfer's ball may be a further alternative.

Other buttons (not shown) or button functionalities (implemented for example by a touch screen) may be included on the recording device 10 (and/or remote triggering device 14) to enable the recording device 10 to record events such as lost balls, penalties, and mulligans. There also may be provisions for correcting errors in capturing ball placement or number of strokes. Provision may also be provided for recording the number of the club (e.g. 5 iron, or 3 wood) used for each stroke.

The recording device 10 also includes a display 18 for showing the number 20 of the hole, the number of strokes 22 that the golfer has taken on the hole he is playing, and the total current cumulative score 24. Other numerical data such as distance to the hole 26 (calculated on the basis of present device position and known hole position), par for the current hole 28, or wind direction and speed (not shown) may also be displayed. Data such as the wind direction and speed, and par for the hole may be provided via a radio frequency (RF) link from a remote location, such as the club house, or by other means known to those skilled in the art. Additionally, the display 18 may be used to show graphical information, such as pin placement on the green or location of hidden hazards. More detailed information may be displayed, such as club selection for shots, or altitude changes from present position to hole. The recording device 10 may be loaded with the particulars of the course at the image processing computer or other station containing the data pertinent to the course. By this means, the recording device 10 may display data for the golfer such as distance to hole, or hidden hazards. The display 18 may be a touch screen so that the ball placement button 12 and hole button 16 are implemented by the touch screen. As with the display 18, a touch screen display can also be used to correct errors in capturing ball placement or number of strokes.

The recording device 10 may also comprise a digital camera 25 having a taking lens 27 located on the recording device 10. The digital camera 25 may be used to capture images during the round of golf, which images can be stored along with the GPS coordinates of the recording device 10 location at the time of image capture in memory. The images can then be used as described below in creating a keepsake of the activity.

The data loaded/transferred to the recording device 10 may include historical data on the performance of one or more of the golfers. The golfer can become aware of tendencies of a population or of his own prior rounds in this fashion. This awareness may improve the golfer's score.

A single recording device 10 could be used for an entire foursome. The recording device 10 would be placed at the site of each golfer's stroke, or a means may be provided for determining the offset of each golfer's ball position from the position of the recording device 10. For example, if the recording device 10 includes an infrared range-finder and a compass, such offsets may be provided automatically by the recording device 10.

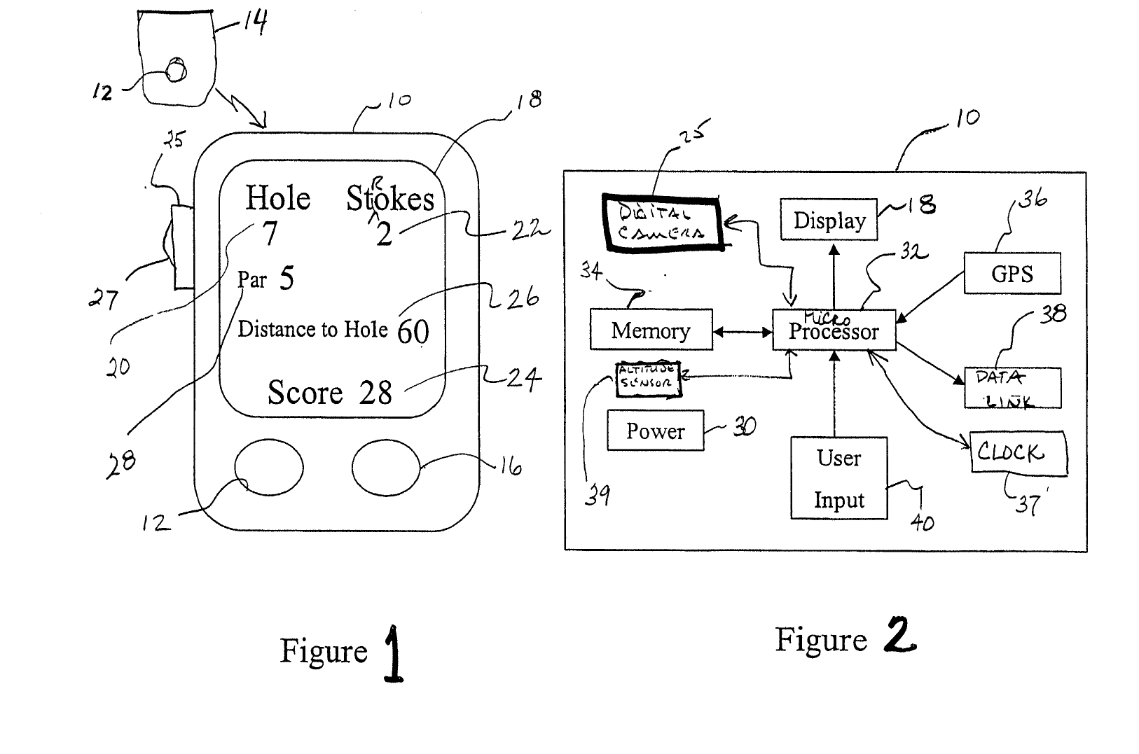

FIG. 2 shows a block diagram of the recording device 10. The recording device 10 includes a power supply 30, such as a battery, and a microprocessor 32. A memory 34, a global position system (GPS) 36, and a data link 38 are connected to the microprocessor 32. Recording device 10 may optionally comprise other components connected to the microprocessor 32. For example, if images are to be collected, the digital camera 25 would be connected to the microprocessor 32. If data regarding date and/or time is to be collected, a clock 37 would be connected to microprocessor 32. Similarly, if data regarding altitude is to be collected, an altitude sensor 39 (such as an altimeter) would be connected to microprocessor 32. The data link 38 can be a data port such as a USB or RS 232 port, or an RF link such as a “Bluetooth” RF module. Inputs to the recording device 10, such as by the aforementioned ball placement button 12, hole button 16, or the touch screen on display 18, are shown in FIG. 2 as user input 40. The user input 40 are connected to the microprocessor 32. In a preferred embodiment, the golfer presses the ball placement button 12 and the microprocessor 32 detects the button press. The microprocessor 32 increments a stroke-counter in memory 34 and detects the position information from the GPS 36 and stores the position information along with a stroke number in memory 34. The display 18 may be updated accordingly to reflect the most recent stroke and distance to hole. The data link 38 provides for downloading to the microprocessor 32 of information pertinent to the course such as par and location of pins and uploading from the microprocessor 32 of stroke and location information captured during the activity to a peripheral device such as an image processing computer or printer, as described below.

Other suitable means known to those skilled in the art for triangulating a location may be employed, such as a cell tower, to detect the coordinates of the golfer's location.

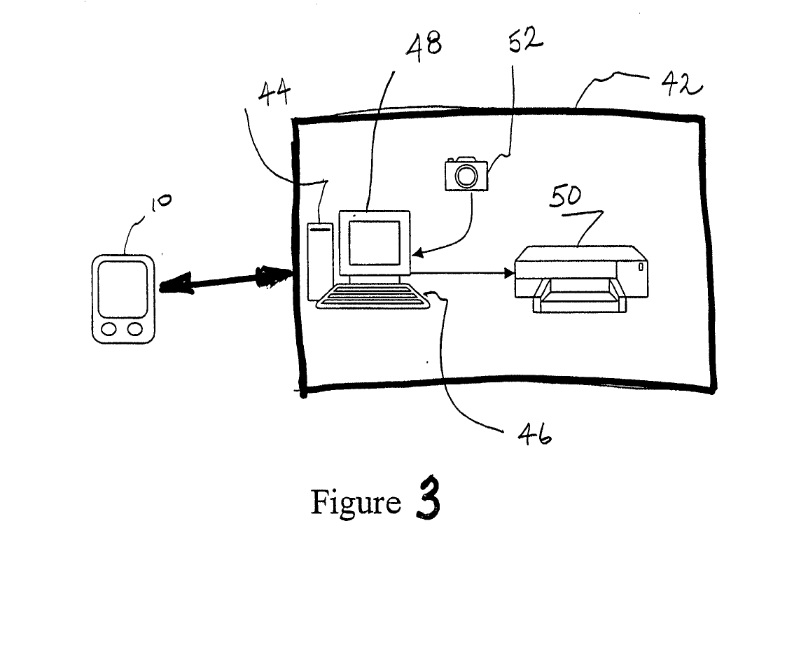

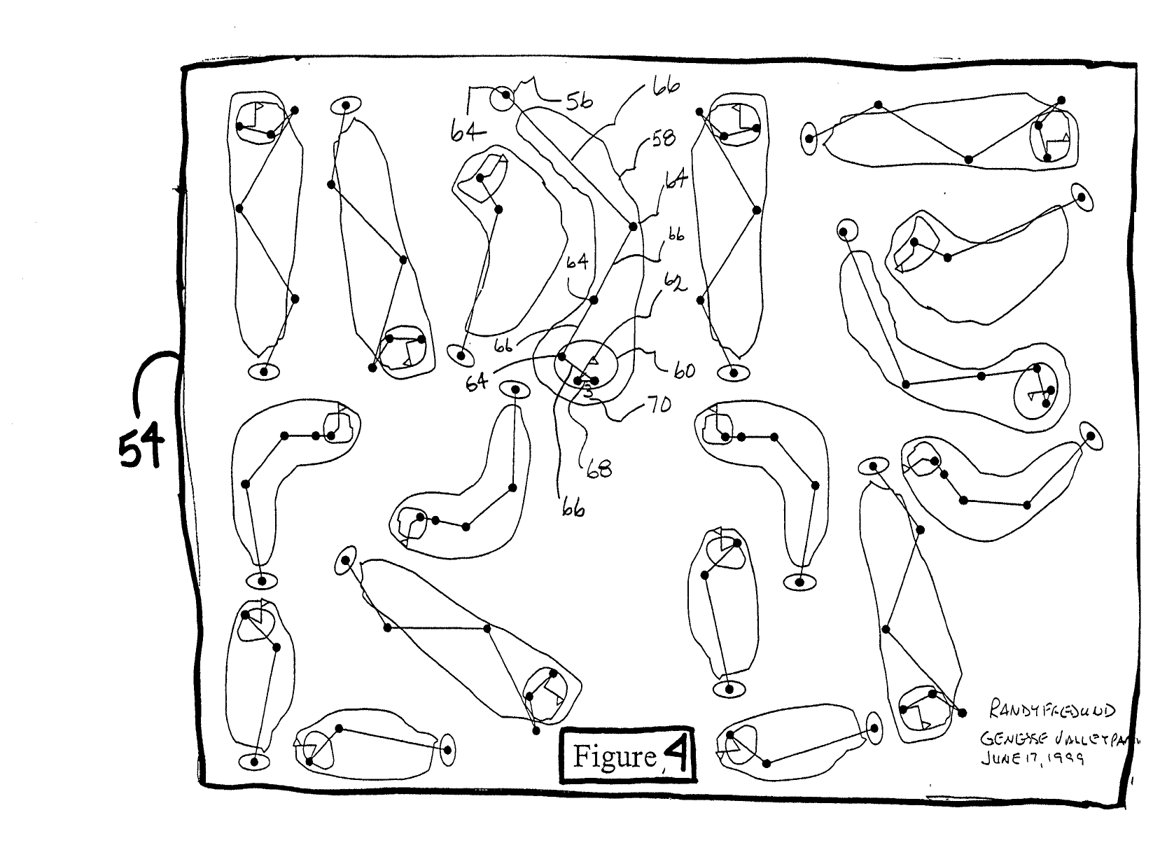

FIG. 3 shows a system in accordance with the present invention comprising an image processing and printing station 42. The station 42 includes an computer 44 for processing image and data information (hereinafter, computer 44 is referred to as image processing computer 44), a user interface 46, such as a keyboard, a computer display 48, and an output device or printer 50,, such as an ink jet or thermal printer, all adapted to be connected to the computer 44. The image processing and printing station 42 may also include a digital camera 52 attached to the image processing computer 44. The digital camera 52 may be used to capture an image of the golfer and the captured image would be integrated into a keepsake as described below. The image processing and printing station 42 may be located for example behind the counter of a pro shop, or preferably as a free standing kiosk located in the pro shop or the club house.

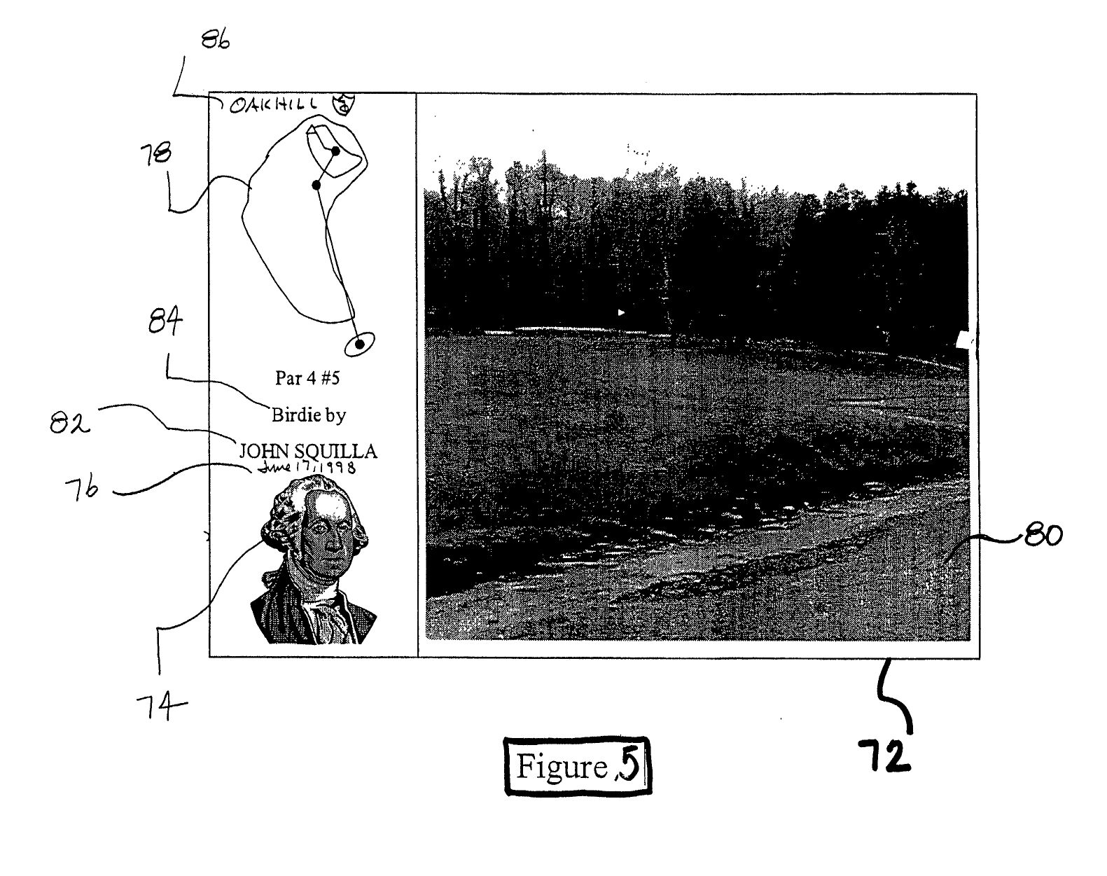

The image processing computer 34 is configured to process the information provided by the recording device 10 and produce an output or output image that is prepared by printer 50. An example of an output image is shown in FIG. 4. As shown FIG. 4, the output image may be a shot map 54 that includes an outline of the golf course showing the location of a tee 56, fairway 58, green 60 (with pin placement 62) for each hole of the course. The golfer's shot locations 64 (represented in FIG. 4 by dots) and approximate ball trajectories 66 (represented in FIG. 4 by lines) are illustrated on the golf course outline. A dot (i.e., shot location 54) and line (i.e., ball trajectory 56) correspond to each stroke the golfer took in the round. The progress of the golfer from tee to hole is displayed graphically on the shot map 54. In areas where the resolution of the shot map 54 or the resolution of the GPS system is inadequate to show the discrete strokes, such as on the green, a single line 68 may be used with a number 70 beside it to indicate the number of strokes. For example, in FIG. 4, the number 70 next to the line 68 is “3”, representing that the golfer took 3 strokes over this distance. The shot map 54 may be a realistic image of the terrain of the golf course, a photograph, such as an aerial photograph, or a realistic rendering of the terrain. Alternatively, the shot map 54 may be a topographical map of the terrain traversed by the route.

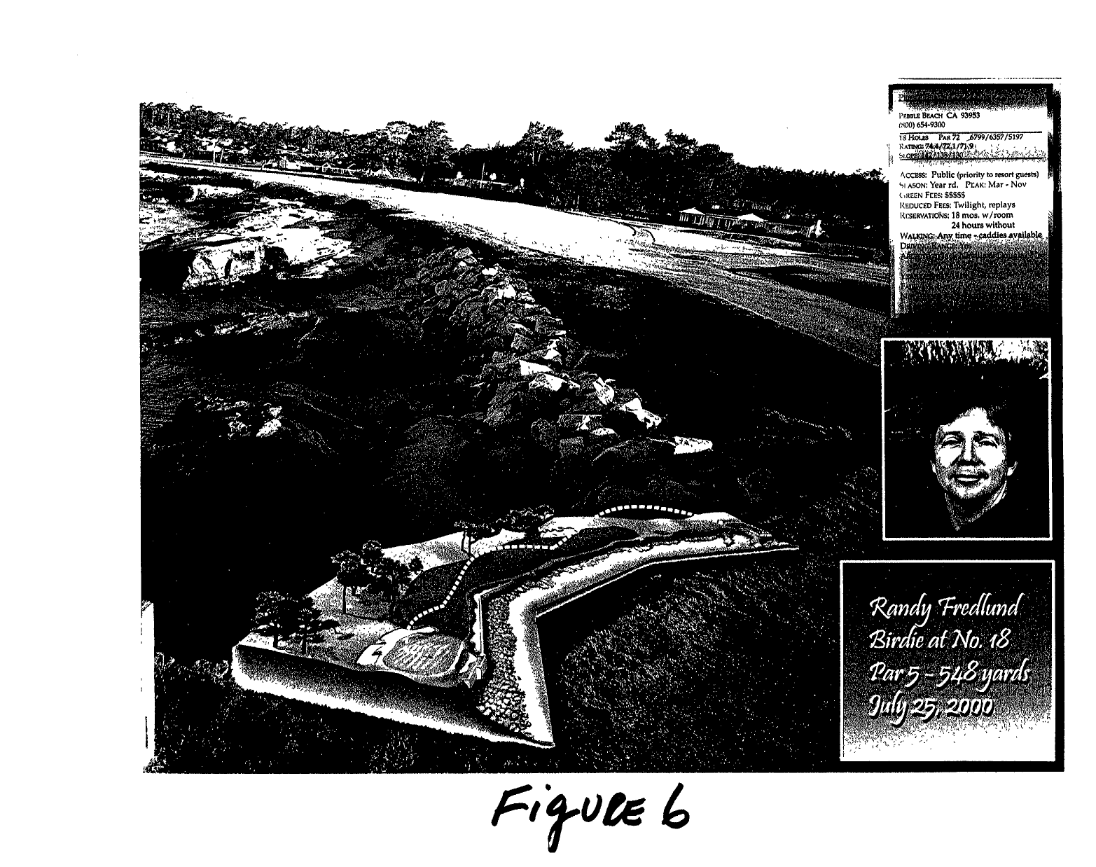

Outputs other than a shot map can be generated by the system in accordance with the present invention. For example, FIG. 5 shows an output 72 suitable as a keepsake. The keepsake image shown in output 72 relates to one particular hole that has been selected from the round of golf for display. The particular hole selected may have been notable, for example, for the golfer's low score or the difficulty associated with the hole. In the keepsake shown in FIG. 5, the output 72 is a composite image comprising, the golfer's portrait 74, which has been captured by the digital camera 52 attached to the image processing computer 44. A date 76 of the activity may be provided automatically by the image processing computer 44, or manually input by an operator. The keyboard 46 may be used to select one particular hole 78 (e.g. hole number 5) and an associated realistic image 80 (such as a photographic or rendered image) of the particular hole, and to input other information such as the golfer's name 82 and a description 84 of the results of the hole. The keyboard may also be used to input personal comments by the golfer to reflect memorial moments about the activity. The image processing computer 44 generates a composite image comprising the user-supplied inputs and previously supplied images of the particular hole that has been selected. Optionally, a club logo and name 86 may be incorporated into the composite image. The composite image is then output on the printer 50 and available for the customer as a remembrance of the activity. In the event that the system of the present invention is incorporated as a kiosk or automatically operated system, the inclusion of automatic means of payment may be desirable. For example, the kiosk may be provided with a means for receiving payment, such as a credit card reader (not shown) known to those skilled in the art.

As described above, the digital image may comprise alphanumeric information and/or iconic information, such as a golf course/club logo and name 86. Such information disposed in the digital image may also include personally-identifiable information, that is, information attributable to the participant. For example, the golfer's name, age, date of birth, handicap, golfer's image, club selection, quotes, comments, and personal reflections.

The representation of the route taken by the golfer may be graphically connected by means of lines, dots, or a combination thereof, for example, dashed lines or a sequence of dots. FIG. 6 illustrates a route taken by a golfer graphically connected by dashed lines. FIG. 6 also illustrates the route shown in exaggerated form, thereby enhancing the keepsake. If the routes of multiple golfers are shown in one digital image, the route of each golfer may be represented by a different graphical connection.

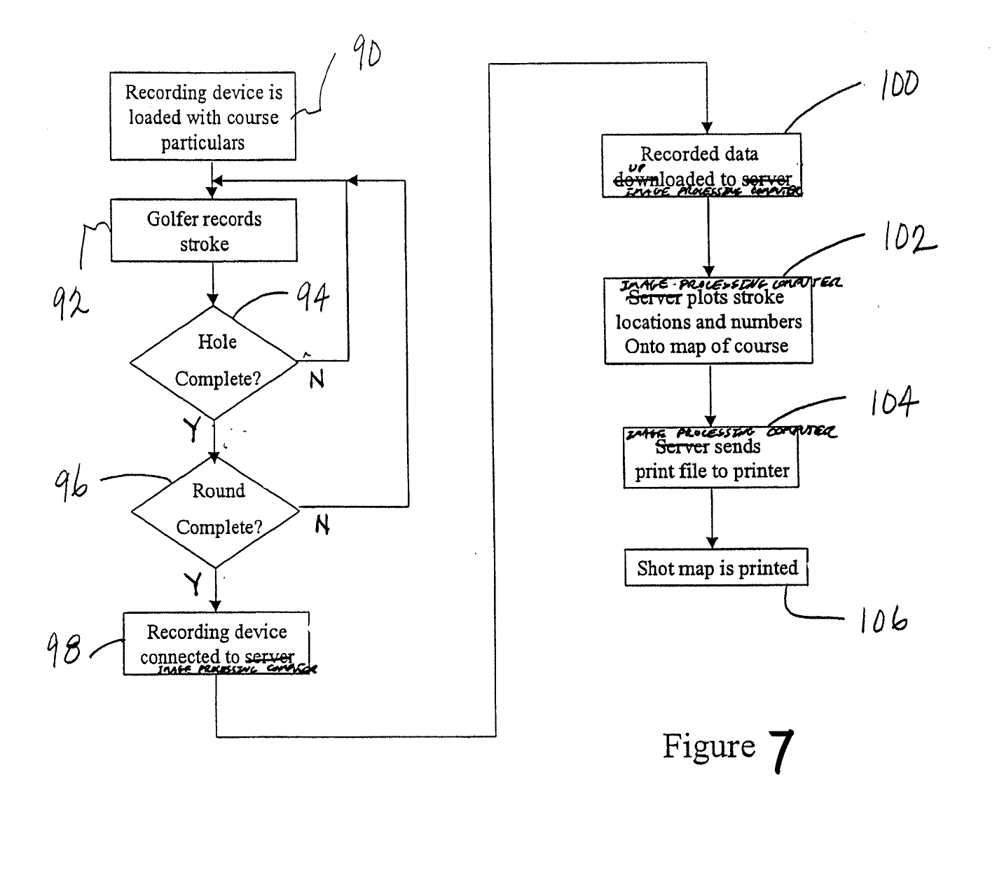

Turing now to FIG. 7, the operation of the system in accordance with the present invention is now described with reference to a flowchart. The recording device 10 is configured/loaded 90 with the particulars of the golf course prior to the golfer beginning the round of golf by means of the data link 38.

Additionally, the recording device 10 may be configured/loaded with the name, or a code corresponding to the identity of the golfer. When the golfer is preparing to take a stroke, he records the stroke 92 by pressing the ball placement button 12. If the hole is not completed 94 with this stroke, the golfer will repeat the process on the next stroke. If the hole is completed, the golfer records the completion by pressing the hole button 16. This sequence is repeated 96 until all the holes on the round are completed.

When all the holes on the round are completed, the recording device 10 is connected 98 to the image processing computer 44 to upload the captured information. As described in more detail above, the recording device 10 may be connected to the image processing computer 44 via an RF link during play. This RF link allows connectivity during play, and will allow the image processing computer 44 to display the performance of the golfer while the round is in progress. This may be desirable if the golfer or many golfers are competing in a tournament. In the case where the recording device 10 is connected to the image processing computer 44 at the end of the activity, the recording device 10 uploads the captured information to the image processing computer 44 at this time 100. Preferably, the captured information includes the GPS position of the golfer for each stroke. Other uploaded information may be an ID for the golfer, club selection for each shot, or images/scenes captured during the round if the recording device 10 is equipped with the digital camera 25.

After the captured information is uploaded, the image processing computer 44 will plot 102 each stroke on the shot map 54 in accordance with known locations on the course map and the ball positions recorded by the golfer. The known locations on the course map are previously loaded into the image processing computer 44. The shot map 54 is displayed, the image processing computer 44 sends 104 the print file to the printer 50, and the shot map is printed 106 on printer 50. The image file of the shot map 54 may additionally be saved to a file on a medium, such as a floppy disk or CD. Such output enables the golfer to view an on-screen representation of his round. Additionally, the image file may be sent to an e-mail address designated by the customer/golfer. Optionally, in addition to documenting the round of one golfer, the shot map 54 may include information corresponding to the shots of other golfers using, for example, different shapes to designate the different golfers, and providing a legend relating the shapes to the identities of the different golfers.

In addition to providing a keepsake image representing a round or hole of golf, the system of the present invention may be used to create keepsake images for other activities such as hiking, fishing, long distance running, mountain climbing, fishing, bicycling, skiing, boating, road rallys, and vacation travel. For such activities, the participant may carry the recording device 10. The recording device 10 would be enabled with buttons to initiate recording of locations, or may be programmed to record locations at regular intervals. In the latter case, the participate/user does not need to regularly actuate the record device 10 to record locations, but rather, would start the recording at the beginning of the activity thereby allowing the recording device 10 to automatically record the activity at regular intervals If the recording device 10 has a display 18, it may also be used to display the user's location on a map previously loaded into the recording device 10 as is known to those familiar in the GPS art.

In addition to the system of the present invention being used to record a particular route taken during an activity and produce a map or keepsake showing the route taken, the system of the present invention can be used as a safety and maintenance tool by the golf course. That is, if the golf course is able to track where the golfer's balls, and thereby the golfers, have been positioned, the grounds crew of the golf course can better understand the areas of the golf course that may require additional maintenance, for example, to repair divots. Alternatively, if the managers of the golf course understand where errant golf shots are most frequent, the managers may be able to modify the golf course to improve the safety for the golfers, for example, by growing natural barriers to deflect errant shots.

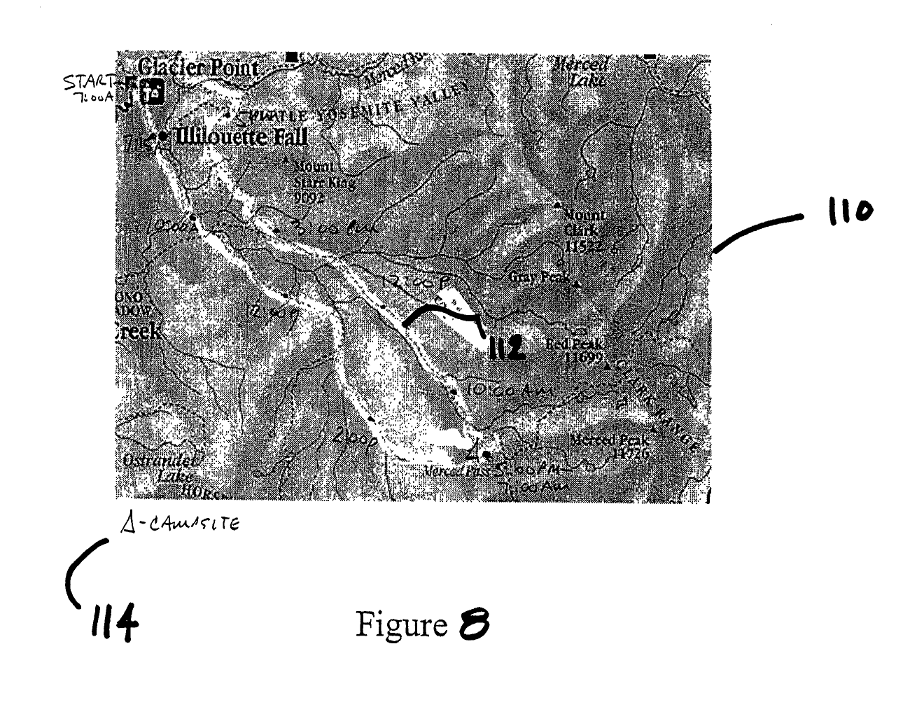

In a manner similar to creating the shot map 54 for golfing, if the participant/user is involved in the activity of hiking, a trail map 110 may be created as a keepsake. That is, the recording device 10 may upload the captured location coordinates from the recording device 10 into the image processing computer 44. The image processing computer 44 uses the coordinates to create the trail map 110 as shown in FIG. 8 that shows the route 112 (shown in dashed lines) taken by the hiker. The trail map 110 is then displayed and printed as described above.

As described above, the recording device 10 may include the clock 37, preferably as part of the microprocessor 32 for recording date and time information along with the GPS coordinate data. If data and time are recorded with each location, the trail map 110 may also show progress along the trail. Icons 114 may be added at or adjacent to locations where an event has occurred. For example, a significant time is spent at a campsite, or the siting of wildlife. Inclusion of times on the map may be of greater significance for sports such as long distance running.

The system of the present invention is also useful for other activities. For mountain climbing, altitude may be equally important as location, and the altitude sensor 39 may be included in the recording device 10. Fishermen may use the system for providing a keepsake detailing size, weight, location and times of fish caught. Accordingly, fish weight can be input as data to the recording device 10.

Vacationing travel may also be chronicled by the system, whereby the output could be a roadmap sized appropriately to the length of the trip.

The invention has been described in detail with particular reference to certain preferred embodiments thereof, but it will be understood that variations and modifications can be effected by a person of ordinary skill in the art without departing from the scope of the invention.

### PARTS LIST

10 recording device

12 ball placement button

14 remote triggering device

16 hole button

18 display

20 number

22 number of strokes

24 total current cumulative score

25 digital camera

26 distance to the hole

27 taking lens

28 par for hole

30 power supply

32 microprocessor

34 memory

36 global position system

37 clock

38 data link

39 altitude sensor

40 user input

42 image processing and printing station

44 image processing computer

46 user interface; keyboard

48 computer display

50 output device

52 digital camera

54 shot map

56 tee

58 fairway

60 green

62 pin placement

64 shot locations

66 ball trajectories

68 line

70 number

72 output keepsake

74 golfer's portrait

76 date of activity

78 selected particular hole

80 associated realistic image

82 name

84 description

90 loaded

92 record

94 hole completed

96 round completed

98 connected

100 uploaded

102 plot

104 send

106 print

110 trail map

112 route

114 icons

What is claimed is:

1. A method for creating a keepsake of an activity involving a route along a plurality of locations, comprising the steps of:
a) providing a participant in the activity with a recording device for recording a location coordinate of the participant's location at various times during the activity;
b) participating in the activity accompanied by the recording device;
c) collecting personally-identifiable information of the participant;
d) employing the location coordinates recorded by the recording device and the personally-identifiable information of the participant to produce a digital image comprising the personally-identifiable information of the participant and the participant's location at various times during the activity; and
e) generating a keepsake of the activity comprising a digital image.

2. The method of claim 1, wherein the recording device includes a global positioning system (GPS) for determining the location coordinates of the participant's locations.

3. The method of claim 1, further comprising the steps of:
collecting a collected image associated with the activity using a digital camera; and
including the collected images in the digital image.

4. The method of claim 1, further comprising the steps of:
recording a respective time of the participant's locations during the activity using a clock; and
including at least one of the recorded times associated with the participant's locations in the digital image.

5. The method of claim 1, further comprising the steps of:
recording a respective elevation of the participant's locations during the activity using an altitude sensor; and
including at least one of the recorded elevations associated with the participant's locations in the digital image.

6. The method of claim 1, wherein the step of collecting personally-identifiable information comprises the steps of:
capturing an image of the participant; and
including the captured image of the participant in the digital image.

7. The method of claim 1, wherein the step of collecting personally-identifiable information comprises the step of collecting the participant's name.

8. The method of claim 1, further comprising the step of including, in the digital image, alphanumeric information or icon information relating to the activity.

9. The method of claim 8, wherein the step of including alphanumeric information is accomplished by manual input to a processing computer.

10. The method of claim 8, wherein the step of including alphanumeric information is accomplished by electronically uploading the alphanumeric information to a processing center.

11. The method of claim 1, wherein the activity is at least one hole of golf, and the participant's locations represents a path of a golf ball hit by the participant.

12. The method of claim 1, wherein the digital image includes a realistic image of a terrain traversed by the participant.

13. The method of claim 1, wherein the digital image includes a topographical map of a terrain traversed by the participant.

14. The method of claim 1, wherein the digital image includes an aerial view of a terrain traversed by the participant.

15. The method of claim 1, further comprising the steps of generating text describing the activity; and compositing the text with the image of the route and the personally-identifiable information of the participant.

16. The method of claim 1, further comprising the step of generating, in the digital image, a representation of the route taken by the participant during the activity by graphically connecting the participant's locations at various times during the activity.

17. The method of claim 1, further comprising the step of generating, in the digital image, at or adjacent to a particular participant location, an icon representative of an event.

18. A method for representing an activity involving a route along a plurality of locations, comprising the steps of:
a) providing a participant in the activity with a recording device for recording the coordinates of the participant's location at various times during the activity;
b) participating in the activity accompanied by the recording device;
c) employing the coordinates recorded by the recording device and the name of the participant to produce a digital image showing the identity of the participant, the location of the participant at various time and the route taken by the participant during the activity; and
d) generating a keepsake of the activity comprising the digital image.

19. The method of claim 18, wherein the step of generating a keepsake of the activity is accomplished by making a print of the digital image.

20. A system for creating a keepsake representing an activity involving a route having a plurality of locations, comprising:
a) a recording device for recording a coordinate of the locations;
b) an image processing computer programmed for generating a digital image showing the locations;
c) a link for downloading the coordinates of the locations to the image processing computer; and
d) an output device for generating the digital image, thereby providing the keepsake of the activity.

21. The system of claim 20, further comprising a global positioning system for determining the coordinates of the locations.

22. The system of claim 20, further comprising a digital camera for collecting images associated with the activity, and the digital image includes the collected image.

23. The system of claim 20, further comprising a clock for recording a respective time of the participant's locations during the activity, and wherein the digital image includes at least one of the recorded times associated with the participant's locations.

24. The system of claim 20, further comprising an altitude sensor for recording a respective elevation of the participant's locations during the activity, and wherein the digital image includes at least one of the recorded elevations associated with the participant's locations.

25. The system of claim 20, including a camera for capturing an image of the participant and wherein the image processing computer is programmed to include the image of the participant in the digital image.

26. The system of claim 20, wherein the digital image includes alphanumeric or iconic information relating the activity.

27. The system of claim 26, wherein the alphanumeric or iconic information relates to an identification, location, or purpose of the activity.

28. The system of claim 26, wherein the alphanumeric or iconic information is disposed at or adjacent to a particular location.

29. The system of claim 20, wherein the activity is at least one hole of golf, and the route represents a path of a golf ball hit by the participant.

30. The system of claim 20, wherein the digital image includes a realistic image of a terrain traversed by the route.

31. The system of claim 20, wherein the digital image includes a topographical map of a terrain traversed by the route.

32. The system of claim 20, wherein the digital image includes an aerial view of a terrain traversed by the route.

33. The system of claim 20, wherein the digital image includes text, an image of the route, and an image of the participant.

34. The system of claim 20 wherein the recording device includes a wireless data link to the image processing computer for uploading the coordinates of the locations.

35. The system of claim 20, wherein the digital image further comprises a representation of the route taken by the participant during the activity defined by a graphical connection of the participant's locations at various times.

36. The system of claim 35, wherein the graphical connection of the participant's locations is accomplished by lines, dots, or a combination thereof.

37. The system of claim 20, wherein the digital image comprises an icon representative of an event of the activity.

38. The system of claim 37, wherein the icon is disposed at or adjacent to a particular participant location.

39. The system of claim 20, wherein the digital image comprises personally-identifiable information.

40. The system of claim 39, wherein the personally-identifiable information comprises an image of the participant.

41. The system of claim 39, wherein the personally-identifiable information comprises a name of the participant.

42. The system of claim 39, wherein the personally-identifiable information comprises a golf club selection made by the participant.

43. The system of claim 39, wherein the personally-identifiable information comprises a name of the participant and names of other individuals participating in the activity with participant.

44. The system of claim 20, wherein the digital image comprises coordinates of the locations of a plurality of participants, and the digital images further comprises a representation of the route taken by each of the plurality of participants, the representation defined by a graphical connection of the coordinates of the locations.

45. The system of claim 44, wherein the graphical connection of the participant's locations is accomplished by lines, dots, or a combination thereof, and the graphical connection for one participant differs from the graphical connection for the other participants.

46. A maintenance system for a golf course, comprising:
a) a recording device for recording a coordinate of the locations at various times for each of a plurality of golfers;
b) an image processing computer programmed for generating a digital image showing the locations recorded by the recording device;
c) a link for downloading the coordinates of the locations to the image processing computer; and
d) an output device for generating the digital image showing the coordinates of the locations recorded by the recording device.

47. A golf assessment tool for a plurality of participants involved in a round of golf having a plurality of locations, comprising:
a) a recording device for recording a coordinate of the locations for each of the participants at various times;
b) an image processing computer programmed for generating a digital image showing the locations for each of the participants;
c) a link for downloading the coordinates of the locations to the image processing computer; and
d) an output device for generating the digital image so as to assess the round of golf of each of the participants.

48. The golf assessment tool of claim 47, wherein the digital image further comprises a representation of a route taken by the participants defined by a graphical connection of the participant's locations at various times.

49. The golf assessment tool of claim 47, wherein the graphical connection of the participant's locations is accomplished by lines, dots, or a combination thereof.
